(19) United States
(12) Patent Application Publication
(10) Pub. No.: US 2008/0284116 A1
(43) Pub. Date: Nov. 20, 2008

(54) Apparatus for chucking workpieces on a machining center

(76) Inventors: Armin Muser, Graz (AT); Josef Muser, Neu-Seiersberg (AT); Miguel Muser, Neu-Seiersberg (AT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 12/073,463

(22) Filed: Mar. 5, 2008

(30) Foreign Application Priority Data
Mar. 6, 2007 (AT) A 357/2007

(51) Int. Cl. B23B 31/12

(52) U.S. Cl. 279/62

(57) ABSTRACT

An apparatus for chucking workpieces (13; 13a, 13b, 13c, 13d, 13e, 13f, 13g, 13h, 13i, 13j) on a machining center (1) includes a base plate (22) having a holding fixture for a clamping jaw (10) of the machining center (1) and at least one clamping surface protruding upwardly from the base plate (22) in the used position and including a plurality of workpiece holding fixtures. An improved possibility for use can be achieved in such a way that the clamping surface is arranged in an integral manner with the base plate (22).

The invention relates to an apparatus for chucking workpieces on a machining center, comprising a base plate having a holding fixture for a clamping jaw of the machining center and at least one clamping surface protruding upwardly from the base plate in the used position and comprising a plurality of workpiece holding fixtures which are arranged at least in part as grooves.

It is common practice in current series production to machine workpieces in a substantially automated way in machining centers. A machining center is understood as being an automated machine tool which carries out various machining processes such as drilling, milling or the like on the workpieces. In order to enable achieving respectively high throughput rates, smaller workpieces are usually fastened to so-called fixturing columns, which are apparatuses which have a plurality of workpiece holding fixtures on which the individual workpieces can be fixed. Said fixturing columns are tightly clamped to the machining center in order to enable the respective machining processes. The apparatus in accordance with the invention concerns such a fixturing column as is described for example in DE 10 2005 009 177 A. A further fixturing column is shown and explained in U.S. Pat. No. 4,828,240 A.

Known fixturing columns are always made up of two mutually separated components: the actual fixturing column consists of one or several clamping surfaces which protrude upwardly in the used position and are provided to receive the individual workpieces. A flange with several bores is usually provided on the bottom side of this component, which flange is provided to be screwed onto a so-called pallet. The pallet is arranged specifically for the respective machining center and comprises on its bottom side a holding fixture for a clamping jaw of the machining center which brings the fixturing column to a precisely defined position and holds the same in said position. This allows using one and the same fixturing column for different machining centers on the one hand and fastening several fixturing columns successively on the same pallet on the other hand.

In the course of substantial optimization of machining centers it has been noted however that one will encounter constructional limits with such a concept of fixturing columns, especially concerning accessibility for individual workpieces. Moreover, the amount of production and mounting work for such concepts is relatively high.

An apparatus for chucking workpieces is known from DE 21 53 463 A, in which fastening points for clamping units are provided on the clamping surfaces. It is thus possible to fix a workpiece, but there are narrow limits concerning the precision in positioning and the applicable forces. A further solution with similar disadvantages has been disclosed in DE 44 37 310 A.

It is the object of the present invention to avoid such disadvantages and to provide an apparatus for chucking workpieces which has a simple configuration and offers improved accessibility of the workpieces for the machining tools.

It is a further object of the present invention to minimize material expenditure and thus production costs.

It is provided in accordance with the invention that the clamping surface is arranged in an integral manner with the base plate and that clamping elements are provided which cooperate with clamping jaws which are guided in the grooves.

The relevant aspect of the present invention is that by omitting the fastening means between the base plate and the clamping surface or clamping surfaces, a constructional arrangement of the fixturing column is achieved which allows an improved access to the individual workpieces. Moreover, improved precision in tool chucking and improved stiffness can be achieved, which thus has a positive effect on the quality of the produced workpieces. Side effects are simple configuration and cost-effective production.

It is especially advantageous in connection with the present invention that the workpieces can be fixed rapidly and securely by actuating the clamping elements. The clamping elements are preferably arranged as spindles which cooperate with the movable clamping jaws within the terms of screw and nut. When the clamping elements are tightened with torque-limited tools, the clamping forces exerted on the tool can be dosed precisely.

An especially advantageous embodiment of the present invention provides that a prismatic clamping body is attached to the base plate which has several clamping surfaces. Said clamping body can have a rectangular, square or even polygonal cross section and is delimited by the individual clamping surfaces. It is thus possible to achieve high stiffness on the one hand and to increase the number of workpieces to be fastened on the other hand.

A solution which is especially advantageous from a constructional viewpoint is given when the base plate protrudes laterally beyond the cross section of the clamping body. An increased contact area of the apparatus is achieved and larger workpieces can be machined because the clamping surfaces are less remote from the central axis of the apparatus.

The accessibility to the individual workpieces especially in the lower region of the fixturing column can be improved especially in such a way that the base plate has an outwardly beveled boundary region. As a result, a larger amount of workpieces can be clamped and shorter tools can be used in individual cases for machining, which thus has a positive effect on the machining precision.

The precision of clamping can be improved by centering pins which are arranged on the bottom side of the base plate or which are received in openings of the base plate.

The workpiece holding fixtures can be arranged in the known manner as grooves with dovetail-like or T-shaped cross section which are preferably arranged horizontally. It is also possible simultaneously or alternatively that the workpiece holding fixtures are arranged as bores in the clamping surface.

The present invention is now explained in closer detail by reference to embodiments shown in the drawings, wherein:

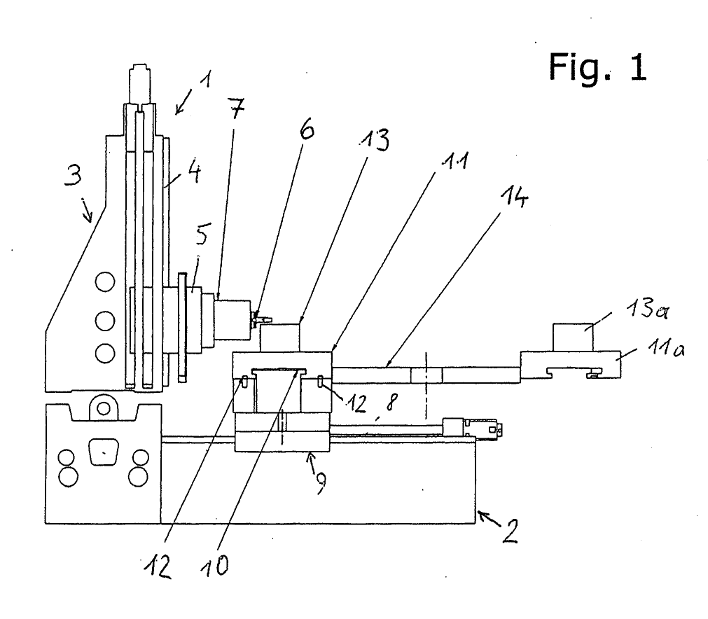

FIG. 1 shows a general schematic representation of a milling center with a chucked workpiece;

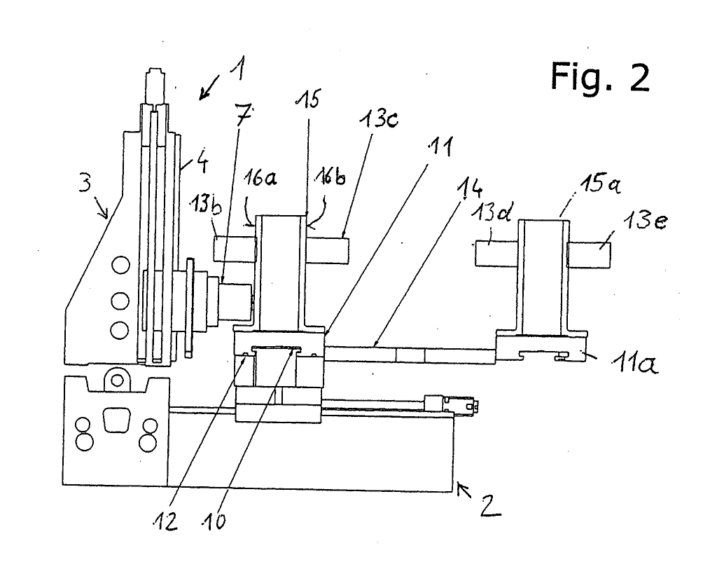

FIG. 2 shows a milling center according to FIG. 1 with a tool column according to the state of the art;

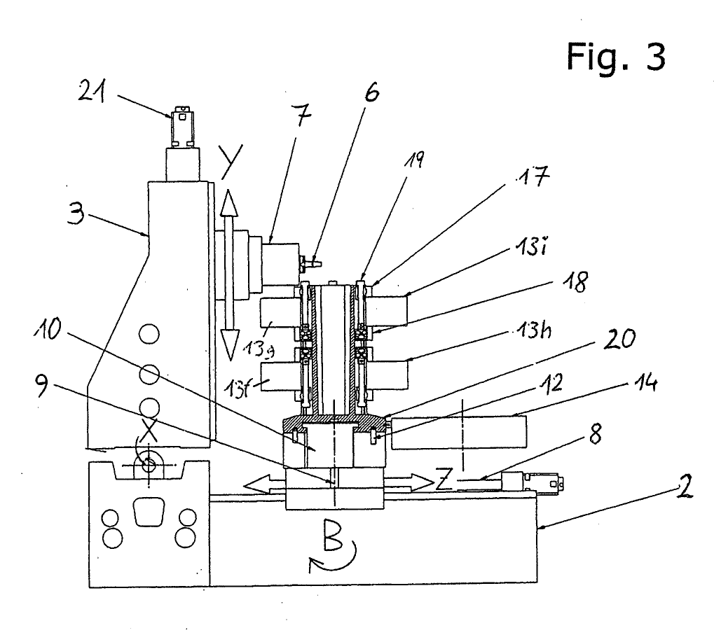

FIG. 3 shows a machining center with an apparatus in accordance with the invention;

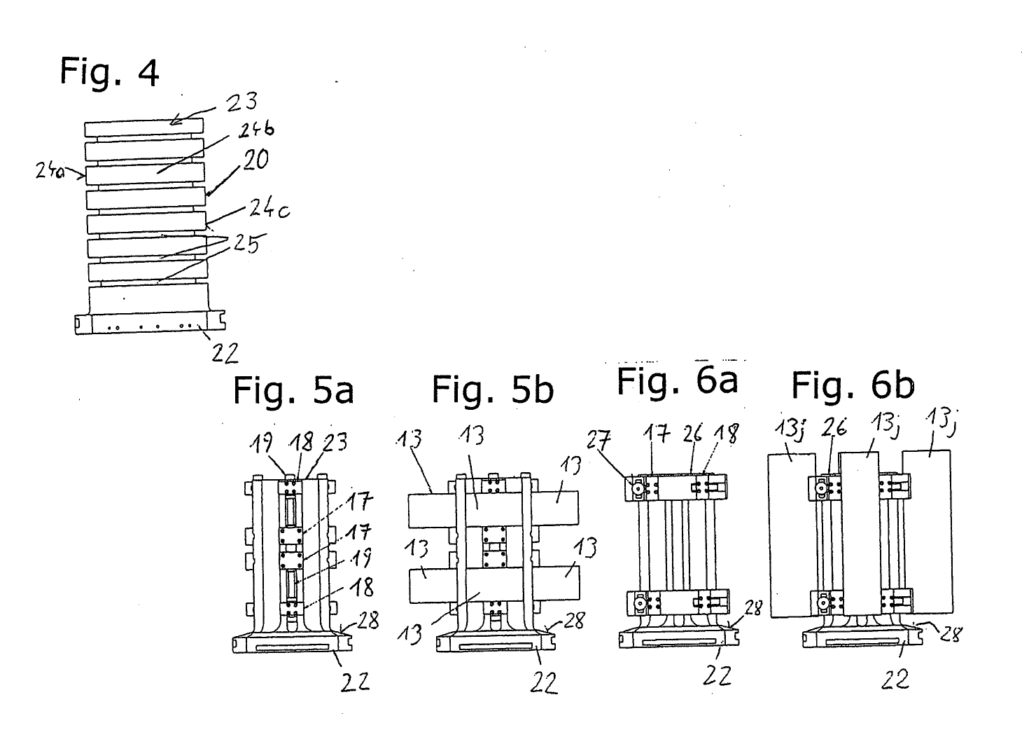

FIG. 4 shows a detailed embodiment of an apparatus in accordance with the invention;

FIG. 5a and FIG. 5b show a further embodiment of the apparatus in accordance with the invention, with and without chucked workpieces;

FIG. 6a and FIG. 6b show an alternative use of the apparatus according to FIG. 5a and FIG. 5b, and

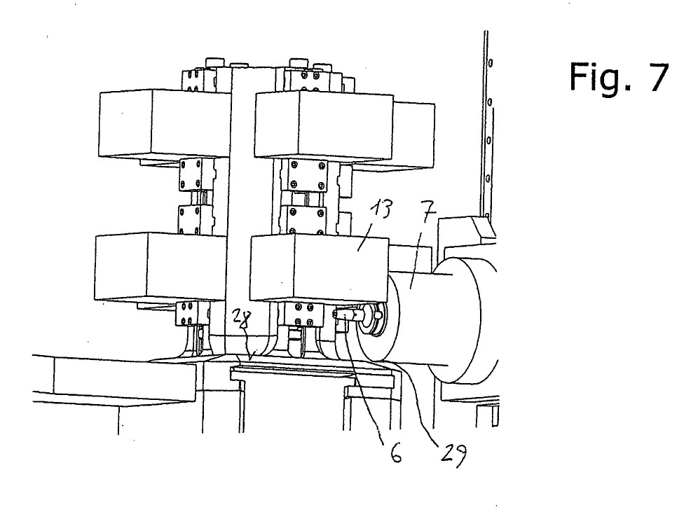

FIG. 7 shows an axonometric view of an apparatus in accordance with the invention in the used state.

The machining center, which is generally designated with reference numeral 1, consists of a machine bed 2 and a tool guide frame 3 on which guide means 4 are arranged in which a carriage 5 slides which carries a tool 6 in a fixture 7. A fixture table 9 is movably fastened in a guide means 8 of the machine bed 2, which table has a clamping jaw 10 with which a pallet 11 can be held in a precisely determined position. Centering pins 12 are used for precisely determining the position of the pallet 11 on the fixture carriage 9. FIG. 1 shows a workpiece 13 which is directly fastened to the pallet 11. A pallet changer 14 allows a rapid change of the pallet 11 with the workpiece 13 to a further pallet 11a with a further workpiece 13a.

Depending on the make of the machine, the pallets 11, 11a are provided with a different arrangement because the fixture table 9 also differs from make to make. The fixture table 9 is usually arranged as a turntable in four-axis machines.

In order to enable the machining of several workpieces in a fixture, so-called fixturing columns are used, as is shown in FIG. 2. A fixturing column 15 is applied in this case to pallet 11, which column bears several workpieces 13b, 13c. These workpieces are tightly clamped to the clamping surfaces 16a, 16b. It can further be seen that through a further pallet 11a it is possible to provide a further fixturing column 15a with further workpieces 13d, 13e in order to prepare the next workpieces for machining.

FIG. 3 shows a machining center on which an apparatus in accordance with the invention is clamped. The individual degrees of freedom which are required for achieving all required working positions of tool 6 are marked with X: adjusting movement in the transversal direction, Y: adjusting movement in the vertical direction, Z: adjusting movement in the longitudinal direction, and B: rotational movement of the fixture table 9. The apparatus in accordance with the invention which in its entirety is designated with reference numeral 20 comprises fixed clamping jaws 17 and adjustable clamping jaws 18 with spindles 19 in order to tightly clamp a plurality of workpieces 13f, 13g, 13h, 13i. A motor for height adjustment (movement in the Y-direction) is designated with reference numeral 21.

FIG. 4 shows the general configuration of an apparatus 20 in accordance with the invention. Apparatus 20 consists of a base plate 22 and the actual fixturing column 23. Fixturing column 23 has a square cross section and is delimited by four clamping surfaces 24a, 24b, 24c. Said clamping surfaces 24a, 24b, 24c have horizontally extending grooves 25 having a T-shaped cross section, in which the clamping shoe can be inserted for fastening workpieces or workpiece holding fixtures.

The embodiment of FIGS. 5a and 5b comprises vertically extending grooves in which fixed clamping jaws 17 and adjustable clamping jaws 18 can be inserted.

In the embodiment of FIGS. 6a and 6b, special fixtures 26 are clamped on the fixed clamping jaws 17 and the adjustable clamping jaws 18 which are arranged to enable the chucking of oblong workpieces 13j via special clamping jaws 27.

FIGS. 5a, 5b and FIGS. 6a, 6b show that the base plate 22 protrudes laterally beyond the fixturing column 23, with the boundary surfaces 28 being beveled to the outside, which improves accessibility for the tools. This is shown especially in FIG. 7. Even when using short tools 6 and workpieces 13 which are arranged in a relatively low way, the fixture 7 for the tool can be displaced in a collision-free way as a result of the beveled side surface 28.

The present invention allows producing fixturing columns which allow an improved access to the individual workpieces.

1. An apparatus for chucking workpieces (13; 13a, 13b, 13c, 13d, 13e, 13f, 13g, 13h, 13i, 13j) on a machining center (1), comprising a base plate (22) having a holding fixture for a clamping jaw (10) of the machining center (1) and at least one clamping surface protruding upwardly from the base plate (22) in the used position and comprising a plurality of workpiece holding fixtures which are arranged at least in part as grooves (25), wherein the clamping surface is arranged in an integral manner with the base plate (22) and that clamping elements are provided which cooperate with clamping jaws (17, 18) which are guided in the grooves (25).

2. An apparatus according to claim 1, wherein the clamping elements are arranged as spindles (19).

3. An apparatus according to claim 2, wherein the spindles (19) cooperate with adjustable clamping jaws (18).

4. An apparatus according to claim 1, wherein a prismatic clamping body is attached to the base plate (22), which body comprises several clamping surfaces.

5. An apparatus according to claim 1, wherein the base plate (22) protrudes laterally beyond the cross section of the clamping body.

6. An apparatus according to claim 1, wherein the base plate (22) has a boundary region (28) which is beveled outwardly.

7. An apparatus according to claim 1, wherein several centering pins (12) or openings for centering pins (12) are provided on the bottom side of the base plate (22).

8. An apparatus according to claim 1, wherein the workpiece holding fixtures are arranged as grooves (25).

9. An apparatus according to claim 8, wherein the grooves (25) are arranged horizontally in the used position.

10. An apparatus according to claim 1, wherein the workpiece holding fixtures are arranged as bores.
